(19) United States
(12) Patent Application Publication
(10) Pub. No.: US 2007/0056211 A1
(43) Pub. Date: Mar. 15, 2007

(54) Candle body composition for colored flame candles and use thereof

(75) Inventors: Hua Li, Jiande Province (CN); Xin Lu, Jiande Province (CN)

Correspondence Address: Paul D. Greeley;Ohlandt, Greeley, Ruggiero & Perle, L.L.P., 10th Floor, One Landmark Square, Stamford, CT, 06901, US

(73) Assignee: Jiande Jiaxuan Articles Co. Ltd.

(21) Appl. No.: 11/500,843

(22) Filed: Aug. 8, 2006

(30) Foreign Application Priority Data
Aug. 8, 2005 (CN) 200510087783.2

(51) Int. Cl. C11C 5/00

(52) U.S. Cl. 44/275

(57) ABSTRACT

The present invention discloses a novel candle body composition for colored flame candles, which can be directly press-molded or provided in any containers in a form of bulk materials and combined with a candle combustion wick to form a colored flame candle. The candle body composition according to the present invention is also suitable for DIY articles. Compared with conventional solid colored flame candles, the colored flame candle according to the present invention can be manufactured in a simple manner, with the heat shaping step being dispensed with and the problem of environmental pollution being largely avoided. Furthermore, the colored flame candle according to the present invention has a good ignition property, a pure and sharp flame and a high retention of flame, and is an environmentally friendly product.

### FIELD OF THE INVENTION

The present invention relates to a novel candle body composition for colored flame candles and use thereof. More particularly, the present invention relates to a candle body composition for colored flame candles with improved production safety, combustion safety and flame stability, and use thereof.

### BRIEF DESCRIPTION OF ART

Conventional colored flame candles are formed of a primary combustion agent, a color-forming agent and other adjuvants, and burn with a colored flame such as red, yellow, blue, green, etc. With respect to the formulations of colored flame candles and processes for manufacturing them, there exist many patent publications. For example, Chinese Patent Application Publication No. CN 1073201A discloses a colored flame candle and manufacture thereof, said colored flame candle comprising an organic polybasic acid ester as the primary combustion agent, a higher fatty acid or higher fatty alcohol as the strength modifier, a higher fatty acid amide as the demoulding agent, metal oxides as the combustion wick modifier and metals or organic salts or complexes thereof as the color-forming agent. However, the colored flame candles disclosed in said prior arts are fragile and less flexible and burn with instable flames. In view of this, the present inventor disclosed in Chinese Patent Application No. 02124149.X a novel colored flame candle and manufacture thereof, said colored flame candle having a high strength and flexibility and thus being not easy to be crushed during its manufacture and marketing. However, the manufacture of all prior colored flame candles involves a conventional melt shaping step and thus is not suitable for DIY articles.

### BRIEF SUMMARY OF THE INVENTION

Under the circumstance mentioned above, the inventors of the present invention conducted extensive investigation in the field of colored flame candles, aiming to develop a colored flame candle suitable for the manufacture requirements of DIY articles, and as the result, the inventors of the present invention found that by adding sucrose fatty acid esters, fatty acid glycerides and higher fatty alcohols during the manufacture of the candle body of the colored flame candle, it is possible to obtain a colored flame candle having a sharp flame without heat shaping. The present invention is completed based on the above finding.

An object of the present invention is to provide a novel candle body composition for colored flame candles. The candle body composition according to the present invention can be directly press-molded or provided in any containers in a form of bulk materials and by combining with a candle combustion wick, gives a colored flame candle; and furthermore, it is suitable for the manufacture requirements of DIY articles. Compared with conventional solid colored flame candles, the heat shaping step is dispensed with and thus the process for manufacturing the colored flame candles is simplified and the problem of environmental pollution is largely avoided.

Another object of the present invention is to provide a novel colored flame candle manufactured from the above-mentioned candle body composition, which has a good ignition property, a pure and sharp flame and a high retention of flame and thus is an environmentally friendly product.

Still another object of the present invention is to provide a process for manufacturing the above-mentioned colored flame candle, which does not need the heat shaping step as conventionally employed for the solid colored flame candles and thus simplifies the manufacture and largely avoids the problem of environmental pollution.

Therefore, the present invention in its one aspect provides a candle body composition for colored flame candles, comprising a primary combustion agent, a sucrose fatty acid ester as the surfactant, a fatty acid glyceride as the antioxidant and anti-mildew agent, a higher fatty alcohol as the combustion adjuvant, a color-forming agent and conventional adjuvants such as essences.

The present invention in its second aspect provides a colored flame candle, comprising a candle body formed from the above-mentioned candle body composition and a candle combustion wick.

The present in its third aspect provides a process for manufacturing the colored flame candle according to the present invention, comprising directly press-molding the above-mentioned candle body composition or providing it in a container in a form of bulk materials and then combining with a candle combustion wick.

### DETAILED DESCRIPTION OF THE INVENTION

The candle body composition for colored flame candles according to the present invention comprises the following components:

| | | |
|---|---|---|
| Primary combustion agent | 60-95% | by weight |
| Color-forming agent | 1-10% | by weight |
| Sucrose fatty acid ester | 1-10% | by weight |
| Fatty acid glyceride | 1-10% | by weight |
| Higher fatty alcohol | 1-10% | by weight |

| | |
|---|---|
| Powdered essence | q.s. |

wherein said percent by weight is calculated on the basis of the total weight of said composition.

The primary combustion agent which can be used in the candle body composition according to the present invention is those conventionally employed in the art and examples thereof may include paraformaldehyde, ethyl hydroxyformate, paraffins, ceresin, ethyl carbamate(urethane), sorbic anhydride, organic polybasic acid esters, polyethylene glycols, hexamethylenetetramine(urotropine), stearic acid, vinyl acetate-ethylene copolymer resins (EVA), etc., and mixtures thereof, preferably ethyl carbamate and organic polybasic acid esters such as di-C₁₋₅ alkyl oxalate, mono-C₁₋₅ alkyl succinate, tri-C₁₋₈ alkyl citrate, etc., and mixtures thereof, more preferably dimethyl oxalate, monomethyl succinate, trimethyl citrate, most preferably trimethyl citrate. The primary combustion agent is used in an amount of 60 to 95% by weight, preferably 65 to 95% by weight, more preferably 75 to 95% by weight, based on the total weight of the composition.

The sucrose fatty acid ester which can be used in the candle body composition according to the present invention is particularly sucrose C₁₀₋₃₀ fatty acid esters, more preferably mono-esters or multi-esters such as biesters, triesters and the like. In a particular embodiment of the present invention, SE series of sucrose fatty acid esters marketed by Longni Fine Chemicals Ltd., Shanghai, China are employed, in particular SE11 to SE15, more preferably SE11 (where the number such as “11” or “15” denotes a hydrophilic-lipophilic balance value (i.e. HLB value)), with the amount thereof being 1 to 10% by weight, preferably 1 to 3% by weight, based on the total weight of the composition.

The fatty acid glyceride which can be used in the candle body composition according to the present invention is fatty acid monoglyeride, fatty acid diglyceride and fatty acid triglyceride, preferably fatty acid monoglyceride, with the amount thereof being 1 to 10% by weight, preferably 1 to 3% by weight, based on the total weight of the composition.

The higher fatty acid alcohol which be used in the candle body composition according to the present invention is C₁₀₋₃₀ fatty alcohols, preferably C₁₂, C₁₆, C₁₈ fatty alcohols or the mixture thereof, more preferably octadecanol, with the amount thereof being 1 to 10% by weight, preferably 1 to 4.5% by weight, based on the total weight of the composition.

The color-forming agent which can be used in the candle body composition according to the present invention is those conventionally employed in the art, and examples thereof may be organic salts such as formates, acetates, stearates and etc., inorganic salts such as halides (for example, chlorides, bromides, etc.), oxycholorides, nitrates, sulfates and etc., of lithium (Li), sodium (Na), potassium (K), boron (B), barium (Ba), calcium (Ca), cesium (Cs), copper (Cu), magnesium (Mg) or antimony (Sb), or complexes of the above-mentioned metals, or mixtures thereof, with the amount thereof being 1 to 10% by weight, preferably 1.5 to 8% by weight, based on the total weight of the composition.

The essences which can be used in the candle body composition according to the present invention is powdered ones conventionally employed in the art. Examples of powdered essences include powdered lemon essence, powdered vanilla essence, powdered orange essence, powdered strawberry essence and the like, with the amount thereof being that conventionally employed in the art, such as 0.001 to 0.1% by weight, preferably 0.005 to 0.05% by weight, based on the total weight of the composition.

Besides the above components, the candle body composition according to the present invention can also comprise oxidation accelerators conventionally employed in the art, such as vanadium pentoxide, chromium trioxide and etc. in amounts conventionally employed in the art.

The candle combustion wick of the colored flame candle according to the present invention can be those conventionally employed in the art, such as cotton combustion wick. The candle combustion wick to be used in the colored flame candle according to the present invention may be subjected to a pretreatment by immersing with a solution of the above-mentioned color-forming agent or other reagents according to a conventional manner in the art. In a particularly preferred embodiment, the candle combustion wick of the colored flame candle according to the present invention is pretreated by immersing with a 10% by weight aqueous hydrogen peroxide solution for 10 minutes and then air-drying, whereby the ignition property and the flame stability are substantially enhanced.

The candle body composition according to the present invention can be directly press-molded or be provided in any containers in a form of bulk materials and then combined with a candle combustion wick to form a colored flame candle. Alternatively, the candle body composition according to the present invention is suitable for the manufacture of DIY articles.

In comparison with the prior methods for manufacturing colored flame candles, the present process does not need the heat shaping step and thus is simplified and largely avoids the problem of environmental pollution.

In comparison with the prior colored flame candles, the colored flame candle according to the present invention has a good ignition property, a pure and sharp flame and a high retention of flame, and is an environmentally friendly product.

### EXAMPLES

The present invention is further demonstrated by the following examples, which shall not be construed as limiting the scope of the present invention.

### Example 1

The formulation for the candle body of a candle with a red flame is as follows:

| | |
|---|---|
| Trimethyl citrate | 94.98% |
| Lithium Propanoate | 1.5% |
| Sucrose fatty acid ester(SE11) | 1% |
| Stearic acid monoglyceride | 1% |
| Octadecanol | 1.5% |
| Powdered vanilla essence | 0.02% |

The above components are added into a container at ambient temperature and then is homogeneously mixed to form a candle body composition. The candle body composition is then added in a form of bulk materials into a mold containing a cotton combustion wick which has been previously pretreated by immersing with a 10% by weight aqueous hydrogen peroxide solution for 10 minutes and then air-drying, or directly press-molded in a mold containing such a pretreated cotton combustion wick to obtain a finished colored flame candle.

### Example 2

The formulation for the candle body of a candle with a yellow flame is as follows:

| | |
|---|---|
| Trimethyl citrate | 94.98% |
| Sodium acetate | 1.5% |
| Sucrose fatty acid ester(SE11) | 1% |
| Stearic acid monoglyceride | 1% |
| Octadecanol | 1.5% |
| Powdered lemon essence | 0.02% |

The colored flame candle is manufactured in a manner same as Example 1.

### Example 3

The formulation for the candle body of a candle with a blue flame is as follows:

| | |
|---|---|
| Trimethyl citrate | 94.98% |
| Potassium aluminum sulfate | 1.5% |
| Sucrose fatty acid ester(SE11) | 1% |
| Stearic acid monoglyceride | 1% |
| Octadecanol | 1.5% |
| Powdered orange essence | 0.02% |

The colored flame candle is manufactured in a manner same as Example 1.

### Example 4

The formulation for the candle body of a candle with a green flame is as follows:

| | |
|---|---|
| Trimethyl citrate | 94.98% |
| Boric acid | 1.5% |
| Sucrose fatty acid ester(SE11) | 1% |
| Stearic acid monoglyceride | 1% |
| Octadecanol | 1.5% |
| Powdered orange essence | 0.02% |

The colored flame candle is manufactured in a manner same as Example 1.

### Example 5

The formulation for the candle body of a candle with a violet flame is as follows:

| | |
|---|---|
| Trimethyl citrate | 94.98% |
| Potassium chloride | 1.5% |
| Sucrose fatty acid ester(SE11) | 1% |
| Stearic acid monoglyceride | 1% |
| Octadecanol | 1.5% |
| Powdered strawberry essence | 0.02% |

The colored flame candle is manufactured in a manner same as Example 1.

### Example 6

The formulation for the candle body of a candle with a magenta flame is as follows:

| | |
|---|---|
| Trimethyl citrate | 94.98% |
| Strontium nitrate | 1.5% |
| Sucrose fatty acid ester(SE11) | 1% |
| Stearic acid monoglyceride | 1% |
| Octadecanol | 1.5% |
| Powdered vanilla essence | 0.02% |

The colored flame candle is manufactured in a manner same as Example 1.

1. A candle body composition for colored flame candles, comprising the following components:

| | | |
|---|---|---|
| Primary combustion agent | 60-95% | by weight |
| Color-forming agent | 1-10% | by weight |
| Sucrose fatty acid ester | 1-10% | by weight |
| Fatty acid glyceride | 1-10% | by weight |
| Higher fatty alcohol | 1-10% | by weight |
| | |
|---|---|
| Powdered essence | q.s. |

wherein said percent by weight is calculated on the basis of the total weight of said composition.

2. The candle body composition as claimed in claim 1, wherein said primary combustion agent is selected from the group consisting of paraformaldehyde, ethyl hydroxyformate, paraffins, ceresin, ethyl carbamate (urethane), sorbic anhydride, organic polybasic acid esters, polyethylene glycols, hexamethylenetetramine(urotropine), stearic acid, vinyl acetate-ethylene copolymer resins (EVA) and mixtures thereof; wherein said combustion agent is used in an amount of 65 to 95% by weight.

3. The candle body composition as claimed in claim 2, wherein said primary combustion agent is selected from the group consisting of ethyl carbamate, di-C₁₋₅ alkyl oxalate, mono-C₁₋₅ alkyl succinate, tri-C₁₋₈ alkyl citrate and mixtures thereof.

4. The candle body composition as claimed in claim 3, wherein said primary combustion agent is trimethyl citrate.

5. The candle body composition as claimed in claim 1, wherein said sucrose fatty acid ester is a mono-ester or a multi-ester, and is used in an amount of 1 to 3% by weight, based on the total weight of said composition.

6. The candle body composition as claimed in claim 5, wherein said sucrose fatty acid ester is SE11 to SE15, preferably SE11.

7. The candle body composition as claimed in claim 1, wherein said fatty acid glyceride is fatty acid monoglyceride, fatty acid diglyceride or fatty acid triglyceride, and is used in an amount of 1 to 3% by weight, based on the total weight of said composition.

8. The candle body composition as claimed in claim 7, wherein said fatty acid glyceride is fatty acid monoglyceride, preferably stearic acid monoglyceride.

9. The candle body composition as claimed in claim 1, wherein said higher fatty alcohol is octadecanol and is used in an amount of 1 to 4.5% by weight, based on the total weight of said composition.

10. The candle body composition as claimed in claim 1, wherein said color-forming agent is organic salts or inorganic salts of lithium (Li), sodium (Na), potassium (K), boron (B), barium (Ba), calcium (Ca), cesium (Cs), copper (Cu), magnesium (Mg) or antimony (Sb), complexes of the above-mentioned metals, or mixtures thereof, and is used in an amount of 1.5 to 8% by weight, based on the total weight of said composition.

11. A process for manufacturing a colored flame candle, comprising the step of directly press-molding a candle body composition comprising the following components:

| | | |
|---|---|---|
| Primary combustion agent | 60-95% | by weight |
| Color-forming agent | 1-10% | by weight |
| Sucrose fatty acid ester | 1-10% | by weight |
| Fatty acid glyceride | 1-10% | by weight |
| Higher fatty alcohol | 1-10% | by weight |
| | |
|---|---|
| Powdered essence | q.s. |

wherein said percent by weight is calculated on the basis of the total weight of said composition.

12. A colored flame candle obtainable by a process as claimed in claim 11, wherein the candle body composition is directly press-molded.

13. The colored flame candle as claimed in claim 12, wherein said candle combustion wick is pretreated by immersing with a 10% by weight aqueous hydrogen peroxide solution for 10 minutes and then air-drying.

14. The candle body composition as claimed in claim 1, wherein said primary combustion agent is 75 to 95% by weight, based on the total weight of said composition.

15. A colored flame candle obtainable by a process as claimed in claim 11, wherein the candle body composition is provided in a container in a form of bulk materials, and a candle combustion wick.

16. A process for manufacturing a colored flame candle as claimed in claim 11, wherein the candle body composition is provided in a container in a form of bulk materials, and then combined with a candle combustion wick.
